(19) United States
(12) Patent Application Publication
(10) Pub. No.: US 2019/0353117 A1
(43) Pub. Date: Nov. 21, 2019

(54) CYLINDER LINER HAVING A FLANGE WITH A VARIED DIAMETER

(71) Applicant: Caterpillar Inc., Deerfield, IL (US)

(72) Inventors: Eric L. Schroeder, Germantown Hills, IL (US); Craig P. Hittle, Dunlap, IL (US); Shu Zhang, Dunlap, IL (US); Nathan Bjerk, Lacon, IL (US); Andrew Schick, Edelstein, IL (US)

(73) Assignee: Caterpillar Inc., Deerfield, IL (US)

(21) Appl. No.: 15/983,331

(22) Filed: May 18, 2018

(51) Int. Cl. F02F 11/00; F02F 1/00; F02F 1/24

(52) U.S. Cl. CPC F02F 11/002; F02F 1/24; F02F 1/004

(57) ABSTRACT

A cylinder liner is disclosed. The cylinder liner may include a generally cylindrical body having a top end and a bottom end. The cylinder liner may include a flange connected to the generally cylindrical body at the top end of the generally cylindrical body. The flange may have an annular surface. A first diameter of a top portion of the annular surface may be less than a second diameter of a bottom portion of the annular surface.

### TECHNICAL FIELD

The present disclosure relates generally to a cylinder liner and, more particularly, to a cylinder liner having a flange with a varied diameter.

### BACKGROUND

Many components of an internal combustion engine, such as a multi-cylinder diesel or gasoline engine, are subjected to high loads and/or wear during operation of the engine. For example, an engine block and/or a cylinder bore of the engine block may experience loads from combustion events occurring within combustion chambers formed by the cylinder head, pistons, and cylinder bores of the engine block. As a result, cylinder bores of the engine block may include a cylinder liner in which the piston reciprocates (e.g., to protect the cylinder bore from stresses experienced during combustion events). A cylinder liner may be adapted for one or more uses and/or functions by varying the design of the cylinder liner.

One attempt to adapt a cylinder liner (e.g., via a flange with a varied diameter) is disclosed in U.S. Patent Application Publication No. 2016/0084193 published on Mar. 24, 2016 (“the '193 application”). In particular, the '193 application discloses a cylinder liner having a flange with an annular groove. The annular groove is formed in the outer annular surface of the flange at an axial location about midway through the axial thickness of the flange. The disclosed cylinder liner may be used in any application where it is desired to increase the reliability and operating life of the associated engine. The disclosed cylinder liner may increase reliability and operating life by enhancing sealing and improving contact pressure consistency at an interface between the cylinder liner and an associated engine block. This enhanced sealing may be provided by increasing flexibility in the flange of the cylinder liner by way of an annular groove.

While the cylinder liner of the '193 application may enhance sealing and improve contact pressure consistency at an interface between the cylinder liner and an associated engine block, other designs of a cylinder liner having a flange with a varied diameter may facilitate other functions and/or uses of the cylinder liner.

The cylinder liner of the present disclosure provides one or more uses that are different than what is set forth above in the art.

### SUMMARY

In one aspect, the present disclosure is related to a cylinder liner. The cylinder liner may include a generally cylindrical body having a top end and a bottom end. The cylinder liner may include a flange connected to the generally cylindrical body at the top end of the generally cylindrical body. The flange may have an annular surface. A first diameter of a top portion of the annular surface may be less than a second diameter of a bottom portion of the annular surface.

In another aspect, the present disclosure is related to a combustion engine. The combustion engine may include an engine block that at least partially defines a plurality of cylinder bores. The combustion engine may include a cylinder liner assembly, within one of the plurality of cylinder bores. The cylinder liner assembly may include a generally cylindrical body having a top end and a bottom end. The generally cylindrical body may have a cylinder liner wall that defines a cylinder liner bore. The cylinder liner assembly may include a flange connected to the generally cylindrical body at the top end of the generally cylindrical body. The flange may have an annular surface. A first diameter of a top portion of the annular surface may be less than a second diameter of a bottom portion of the annular surface. The flange may have a gasket recess configured for a gasket. The combustion engine may include a cylinder head configured to, in combination with the gasket and using one of a plurality of counter bores in the cylinder head, seal the one of the plurality of cylinder bores.

In yet another aspect, the present disclosure is related to a cylinder liner assembly. The cylinder liner assembly may include a generally cylindrical body having a top end and a bottom end. The cylinder liner assembly may include a flange connected to the generally cylindrical body at the top end of the generally cylindrical body. The flange may have an annular surface. A first diameter of a top portion of the annular surface may be less than a second diameter of a bottom portion of the annular surface. A cylinder liner wall of the generally cylindrical body and the flange may define a cylinder liner bore. The cylinder liner assembly may include a gasket recess in a top surface of the flange. The cylinder liner assembly may include a gasket in the gasket recess.

### BRIEF DESCRIPTION OF THE DRAWINGS

FIG. 1 is a diagram of an example engine block of an engine;

FIG. 2 is a diagram of an example top deck of the engine block of FIG. 1;

FIG. 3 is a diagram of an example cylinder liner having a flange with a varied diameter;

FIG. 4 is a diagram of a cross-sectional view of an engine block with the cylinder liner of FIG. 3 installed therein; and

FIG. 5 is a diagram of another cross-sectional view of the engine block of

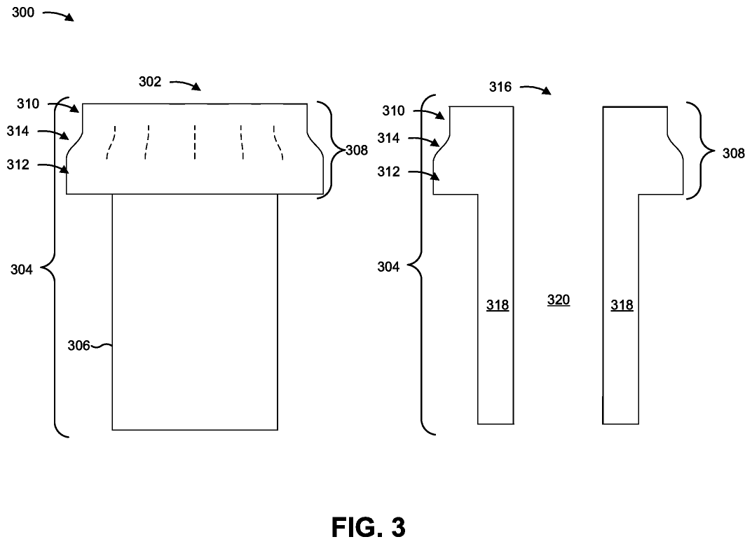

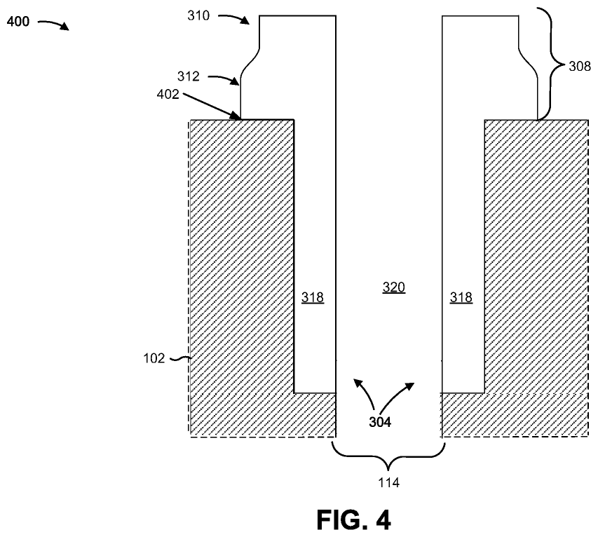

FIG. 4 with the cylinder liner of FIG. 3 installed therein.

### DETAILED DESCRIPTION

This disclosure relates to a cylinder liner. The cylinder liner has universal applicability to any machine utilizing such a cylinder liner. The term “machine” may refer to any machine that performs an operation associated with an industry such as, for example, mining, construction, farming, transportation, or any other industry. As some examples, the machine may be a vehicle, a backhoe loader, a cold planer, a wheel loader, a compactor, a feller buncher, a forest machine, a forwarder, a harvester, an excavator, an industrial loader, a knuckleboom loader, a material handler, a motor grader, a pipelayer, a road reclaimer, a skid steer loader, a skidder, a telehandler, a tractor, a dozer, a tractor scraper, or other paving or underground mining equipment. Moreover, one or more implements may be connected to the machine and driven from an engine that includes a cylinder liner.

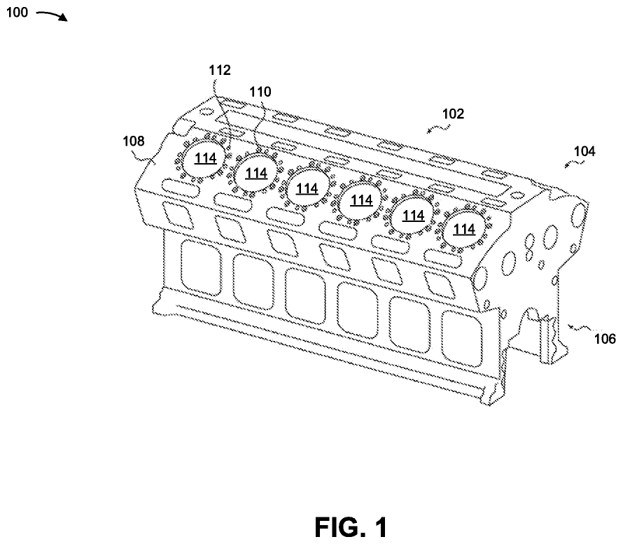

FIG. 1 is a diagram 100 of an example engine block of an engine. For example, FIG. 1 shows an engine block 102 of an engine. Engine block 102 can also be referred to as a cylinder block. Engine block 102 may, for example, be constructed of cast iron, aluminum, magnesium, stainless steel, or any other suitable material. Engine block 102 may be used in compression ignition engines or spark ignited engines that are utilized to power a machine.

Engine block 102 may be made from a one-piece casting and may include an upper section 104 and a lower section 106. The upper section 104 may include a variety of openings on a top deck 108, such as cylinder bores 114, attachment bores 110, and fluid passages 112. Although six-cylinder bores 114 are shown, engine block 102 may include any number of cylinder bores 114 depending on the configuration of the engine being utilized. A cylinder head (not shown in FIG. 1) may be attached to engine block 102 by using, for example, a plurality of attaching bolts received within the corresponding number of attachment bores 110. The cylinder head may seal cylinder bores 114, thus creating combustion chambers within engine block 102, and may additionally provide a structure for supporting intake and exhaust valves and/or ports, fuel injectors, linkages, and other components that are used to combust the fuel. As further shown, upper section 104 of engine block 102 may include a plurality of fluid passages 112, such as water passages, circumferentially spaced around cylinder bore 114. Any number of fluid passages 112 may be provided throughout engine block 102 and may be formed within the inner portion of engine block 102 (e.g., of lower section 106 and upper section 104) and may open through top deck 108. Fluid passages 112 may form a water jacket or another similar cooling system for controlling circulation of cooling fluids and may provide proper cooling of engine block 102.

As indicated above, FIG. 1 is provided as an example. Other examples are possible and may differ from what was described in connection with FIG. 1. In some implementations, engine block 102 may include additional elements, fewer elements, different elements, or differently arranged elements than those shown in FIG. 1.

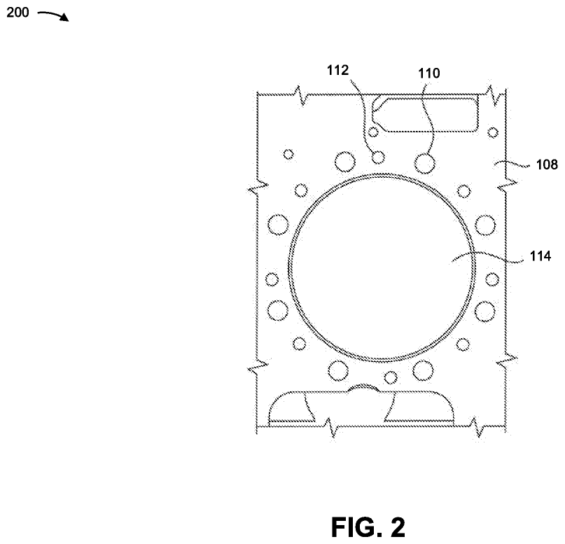

FIG. 2 is a diagram 200 of an example top deck of the engine block of FIG. 1. For example, FIG. 2 shows a top-view of an example configuration of top deck 108 of engine block 102 (e.g., a configuration of cylinder bore 114 and corresponding attachment bores 110 and fluid passages 112 of top deck 108).

In some implementations, a cylinder liner, described herein, may be installed in cylinder bore 114. In this configuration, when engine block 102 is not counter-bored for a flange of a cylinder liner (or where the cylinder liner is used with a counter-bored cylinder head), a bottom edge of the flange of the cylinder liner may contact a top surface of top deck 108, as described elsewhere herein.

As indicated above, FIG. 2 is provided as an example. Other examples are possible and may differ from what was described in connection with FIG. 2. In some implementations, top deck 108 may include additional elements, fewer elements, different elements, or differently arranged elements than those shown in FIG. 2.

FIG. 3 is a diagram 300 of an example cylinder liner having a flange with a varied diameter. For example, FIG. 3 shows various views of the cylinder liner (or a cylinder liner assembly).

Reference number 302 shows a side view of cylinder liner 304. For example, cylinder liner 304 may include a cylinder liner to be used in engine block 102 (e.g., that is configured for a counter-bored cylinder head, that includes a straight bored cylinder bore 114, and/or the like). In some implementations, cylinder liner 304 may include a generally cylindrical cylinder liner body 306. Cylinder liner body 306 may include a top end and a bottom end and cylinder liner 304 may include a flange 308 connected to cylinder liner body 306 at the top end of cylinder liner body 306. In some implementations, flange 308 may be generally cylindrical, similar to cylinder liner body 306. A bottom surface of flange 308 may contact a top surface of engine block 102 when cylinder liner 304 is installed in cylinder bore 114 of engine block 102, as described elsewhere herein. In addition, a top surface of flange 308 may include a gasket (e.g., in a gasket recess of the top surface), which in combination with the top surface of flange 308, may contact a cylinder head to form and/or seal a combustion chamber when the cylinder head is mounted to engine block 102.

Flange 308 may include an annular surface (e.g., an outer surface of flange 308). Reference numbers 310 through 314 show various portions of the annular surface. For example, the annular surface may include a top portion 310 and a bottom portion 312. As further shown in FIG. 3, a diameter of top portion 310 may be less than a diameter of bottom portion 312. For example, the diameter of top portion 310 may be between approximately 98.5 percent and approximately 99.5 percent of the diameter of bottom portion 312. In other words, the diameter of bottom portion 312 may be between approximately 1.015 times and approximately 1.005 times larger than the diameter of top portion 310. In some implementations, the respective diameters of top portion 310 and bottom portion 312 may be substantially constant around a circumference of flange 308. In some implementations, the diameter of top portion 310 may be configured to accommodate a portion of a cylinder head when cylinder liner 304 is installed in engine block 102 and the cylinder head is mounted to engine block 102. As a result, the relative diameters of flange 308 may be different from that described above.

In some implementations, and as further shown in FIG. 3, the annular surface of flange 308 may include a middle portion 314. For example, middle portion 314 may be between top portion 310 and bottom portion 312. In some implementations, middle portion 314 may connect top portion 310 and bottom portion 312. In some implementations, a diameter of middle portion 314 may not be constant around a circumference of flange 308. For example, middle portion 314 may have a variable diameter that is approximately a same diameter as the diameter of top portion 310 at one end of middle portion 314 (e.g., the end that connects to top portion 310) and approximately a same diameter as the diameter of bottom portion 312 at another end of middle portion 314 (e.g., the end that connects to bottom portion 312) to provide a sloping transition between the diameter of top portion 310 and the diameter of bottom portion 312.

While FIG. 3 shows flange 308 as including middle portion 314 to provide a sloping transition between the diameter of top portion 310 and the diameter of bottom portion 312, flange 308 may be configured in a different manner. For example, flange 308 may not include middle portion 314. In this case, the diameter of top portion 310 may transition to the diameter of bottom portion 312 in a step manner (e.g., where top portion 310 is directly connected to bottom portion 312). In some implementations, and as another example, rather than providing a sloping transition between top portion 310 and bottom portion 312, middle portion 314 may provide a stepping transition between top portion 310 and bottom portion 312 (e.g., where a set of sub-portions of middle portion 314 have different diameters between the diameter of top portion 310 and bottom portion 312. In some implementations, and as another example, flange 308 may include a single portion that transitions from a first diameter at a top end of flange 308 to second diameter at a bottom end of flange 308 (e.g., in a sloping manner).

Although flange 308 is described as having different portions, in practice, flange 308 may be a single element (e.g., cast as a single element separate from, or in combination with, cylinder liner body 306). Conversely, the different portions described with regard to flange 308 may be cast as separate elements and attached to each other and/or cylinder liner body 306 via welding, use of an adhesive, and/or the like.

Reference number 316 shows a cross-sectional view of cylinder liner 304. As shown, cylinder liner 304 further includes cylinder liner wall 318 that forms the generally cylindrical shape of cylinder liner body 306 and/or flange 308. In some implementations, cylinder liner 304 may include a cylinder liner bore 320 (e.g., formed by cylinder liner wall 318). In some implementations, cylinder liner bore 320 may be a generally cylindrical cavity in which a piston (not shown) of an engine may move when cylinder liner 304 is installed in engine block 102 and the engine is driving the piston.

As indicated above, FIG. 3 is provided as an example. Other examples are possible and may differ from what was described in connection with FIG. 3. In some implementations, cylinder liner 304 may include additional elements, fewer elements, different elements, or differently arranged elements than those shown in FIG. 3. Further, a simplified version of cylinder liner 304 is shown in and/or described in connection with FIG. 3 for illustrative and/or explanatory purposes. For example, cylinder liner 304 may include various bands, gaskets, seals, inserts, and/or recesses to receive any of the aforementioned elements, and/or the like not shown in and/or described in connection with FIG. 3. In addition, the elements shown in FIG. 3 may not be shown to scale. For example, the relative size of elements of cylinder liner 304 may have been exaggerated to emphasize features of the elements and/or for illustrative and/or explanatory purposes.

FIG. 4 is a diagram 400 of a cross-sectional view of an engine block with cylinder liner of FIG. 3 installed therein. For example, FIG. 4 shows a cross-sectional view of engine block 102 with cylinder liner 304 installed therein (e.g., in cylinder bore 114 of engine block 102). For FIG. 4, assume that cylinder bore 114 of engine block 102 is not counter-bored to accommodate flange 308 (e.g., may be straight bored). In this case, a counter-bored cylinder head (not shown in FIG. 4) would be used in association with the particular engine block 102 shown in FIG. 4.

As shown by reference number 402, cylinder liner 304 may be configured such that a bottom surface of flange 308 contacts a top surface of engine block 102 when cylinder liner 304 is installed in cylinder bore 114 of engine block 102. In some implementations, and as further shown by reference number 402, flange 308 may be above the top surface of engine block 102 while cylinder liner body 306 is within cylinder bore 114 (e.g., to cause flange 308 to be positioned to create a seal with a cylinder head). As described in more detail below, the configuration of the diameters of top portion 310 and bottom portion 312 of flange 308 provide different clearance paths for a cylinder head (not shown in FIG. 4). For example, the smaller diameter of top portion 310 allows for a smaller diameter cylinder head and/or a tighter clearance path of the cylinder head with cylinder liner bore 320, relative to the diameter of bottom portion 312.

As indicated above, FIG. 4 is provided as an example. Other examples are possible and may differ from what was described in connection with FIG. 4. Similar to that described elsewhere herein, FIG. 4 may show a simplified and/or exaggerated version of various elements for illustrative and/or explanatory purposes. The number and arrangement of elements shown in FIG. 4 are provided as an example. In practice, there may be additional elements, fewer elements, different elements, or differently arranged elements than those shown in FIG. 4.

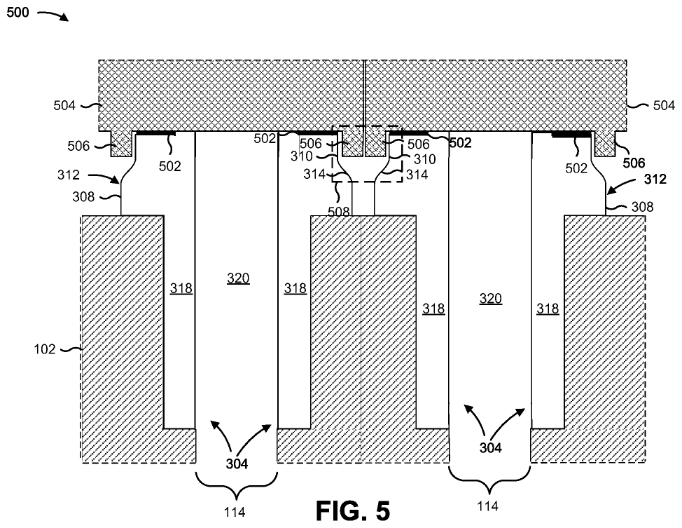

FIG. 5 is a diagram 500 of another cross-sectional view of the engine block of FIG. 4 with the cylinder liner of FIG. 3 installed therein. For example, FIG. 5 shows another cross-sectional view of engine block 102 with cylinder liner 304 installed therein. FIG. 5 shows multiple cylinder liners 304 installed in respective cylinder bores 114 of engine block 102 with a cylinder head (or cylinder heads) installed on engine block 102.

As shown in FIG. 5, gasket 502 may be installed in a recess of flange 308. As further shown in FIG. 5, cylinder head 504 may be installed on engine block 102 to seal cylinder bore 114 and/or cylinder liner bore 320, such as to form a combustion chamber. In some implementations, cylinder head 504 may include a mounting guide 506 that is around top portion 310 of the annular surface of flange 308 when cylinder head 504 is installed on engine block 102. For example, mounting guide 506 may be a ringed lip that can aid a technician in mounting cylinder head 504 on engine block 102 and/or may help to seal cylinder bore 114 and/or cylinder liner bore 320. In some implementations, mounting guide 506 may define, or be associated with, a counter bore of cylinder head 504 (e.g., a counter bore in which top portion 310 of flange 308 is to be sealed). As shown by reference number 508, the smaller diameter of top portion 310 allows for a smaller diameter of mounting guide 506 and/or additional clearance for mounting guide 506 relative to the diameter of bottom portion 312. This in turn facilitates a tighter pitch between adjacent cylinder liners 304 and/or adjacent cylinder bores 114.

As indicated above, FIG. 5 is provided merely as an example. Other examples are possible and may differ from what was described with regard to FIG. 5. Similar to that described elsewhere herein, FIG. 5 may show a simplified and/or exaggerated version of various elements for illustrative and/or explanatory purposes. The number and arrangement of elements shown in FIG. 5 are provided as an example. In practice, there may be additional elements, fewer elements, different elements, or differently arranged elements than those shown in FIG. 5.

### INDUSTRIAL APPLICABILITY

The disclosed cylinder liner 304 may be used with any engine block 102, where cylinder bores 114 of engine block 102 are configured such that flange 308 does not rest in (or entirely in) cylinder bore 114. By including a smaller diameter top portion 310 of flange 308 relative to bottom portion 312 of flange 308, cylinder liner 304 facilitates a tighter pitch between adjacent cylinder bores 114, a tighter pitch between adjacent cylinder liners 304 when installed in engine block 102, and/or the like. For example, the smaller diameter of top portion 310 may facilitate a tighter draft of mounting guide 506 to cylinder bore 114 and/or cylinder liner bore 320. This, in turn, can facilitate a smaller dimension engine block 102 while maintaining a quantity of cylinders bores 114 in engine block 102, a higher quantity of cylinder bores 114 while maintaining a size of engine block 102, and/or the like. Additionally, or alternatively, this can facilitate tighter sealing of a combustion chamber, can reduce costs associated with manufacturing cylinder head 504 (e.g., via a smaller cylinder head 504), and/or the like.

Further, this facilitates use of cylinder liner 304 with different sized engines 102 (e.g., engines 102 that may have different amounts of pitch between cylinder bores 114), that may be associated with different sized cylinder heads 504 (e.g., cylinder heads 504 that have different load paths), and/or the like. Further, cylinder liner 304 may facilitate conservation of space in an engine compartment of a vehicle by facilitating use of a smaller sized cylinder head 504 (e.g., relative to another cylinder head 504 that would be used with another cylinder liner that includes another flange with a diameter that is the same at the top of the flange as at the bottom of the flange), by facilitating use of a smaller engine block (e.g., via a tighter configuration of cylinder bores 114), and/or the like without compromising a diameter of cylinder bore 114.

As used herein, the articles “a” and “an” are intended to include one or more items, and may be used interchangeably with “one or more.” Also, as used herein, the terms “has,” “have,” “having,” or the like are intended to be open-ended terms. Further, the phrase “based on” is intended to mean “based, at least in part, on.”

The foregoing disclosure provides illustration and description, but is not intended to be exhaustive or to limit the implementations to the precise form disclosed. Modifications and variations are possible in light of the above disclosure or may be acquired from practice of the implementations. It is intended that the specification be considered as an example only, with a true scope of the disclosure being indicated by the following claims and their equivalents. Even though particular combinations of features are recited in the claims and/or disclosed in the specification, these combinations are not intended to limit the disclosure of possible implementations. Although each dependent claim listed below may directly depend on only one claim, the disclosure of possible implementations includes each dependent claim in combination with every other claim in the claim set.

What is claimed is:

1. A cylinder liner, comprising:
a generally cylindrical body having a top end and a bottom end; and
a flange connected to the generally cylindrical body at the top end of the generally cylindrical body,
wherein the flange has an annular surface,
wherein a first diameter of a top portion of the annular surface is less than a second diameter of a bottom portion of the annular surface.

2. The cylinder liner of claim 1, wherein the first diameter is between approximately 98.5 percent and approximately 99.5 percent of the second diameter.

3. The cylinder liner of claim 1, wherein the first diameter is substantially constant around a circumference of the flange.

4. The cylinder liner of claim 1, wherein the second diameter is substantially constant around a circumference of the flange.

5. The cylinder liner of claim 1, wherein the flange further comprises a middle portion of the annular surface between the top portion and the bottom portion,
wherein the middle portion connects the top portion and the bottom portion.

6. The cylinder liner of claim 5, wherein the middle portion has a variable diameter that is approximately a same diameter as the first diameter at one end of the middle portion and approximately a same diameter as the second diameter at another end of the middle portion.

7. The cylinder liner of claim 1, wherein the flange, in combination with a cylinder head, is configured to seal a cylinder bore of an engine block of a combustion engine,
wherein the cylinder head is bored to accommodate the flange.

8. A combustion engine, comprising:
an engine block that at least partially defines a plurality of cylinder bores;
a cylinder liner assembly, within one of the plurality of cylinder bores, comprising:
a generally cylindrical body having a top end and a bottom end,
wherein the generally cylindrical body has a cylinder liner wall that defines a cylinder liner bore; and
a flange connected to the generally cylindrical body at the top end of the generally cylindrical body,
wherein the flange has an annular surface,
wherein a first diameter of a top portion of the annular surface is less than a second diameter of a bottom portion of the annular surface,
wherein the flange has a gasket recess configured for a gasket; and
a cylinder head configured to, in combination with the gasket and using one of a plurality of counter bores in the cylinder head, seal the one of the plurality of cylinder bores.

9. The combustion engine of claim 8, wherein the second diameter is between approximately 1.015 times and approximately 1.005 times larger than the first diameter.

10. The combustion engine of claim 8, wherein the first diameter of the top portion is configured to accommodate a portion of the cylinder head.

11. The combustion engine of claim 8, wherein the flange further comprises a bottom surface configured to contact a top surface of the engine block so that the flange is above the top surface and within the one of the plurality of counter bores.

12. The combustion engine of claim 8, wherein the first diameter transitions to the second diameter in a step manner.

13. The combustion engine of claim 8, wherein the flange further comprises a middle portion between the top portion and the bottom portion,
wherein the middle portion connects the top portion and the bottom portion.

14. The combustion engine of claim 13, wherein the middle portion comprises a third diameter,
wherein the third diameter is not constant around a circumference of the flange.

15. A cylinder liner assembly, comprising:
a generally cylindrical body having a top end and a bottom end; and
a flange connected to the generally cylindrical body at the top end of the generally cylindrical body,
wherein the flange has an annular surface,
wherein a first diameter of a top portion of the annular surface is less than a second diameter of a bottom portion of the annular surface,
wherein a cylinder liner wall of the generally cylindrical body and the flange defines a cylinder liner bore;
a gasket recess in a top surface of the flange; and
a gasket in the gasket recess.

16. The cylinder liner assembly of claim 15, wherein the flange further comprises a bottom surface configured to contact a top surface of an engine block.

17. The cylinder liner assembly of claim 16, wherein the bottom surface is further configured to cause the flange to be positioned to create a seal between the cylinder liner bore and a counter bore of a cylinder head.

18. The cylinder liner assembly of claim 15, wherein the first diameter is approximately constant around the annular surface of the flange.

19. The cylinder liner assembly of claim 15, wherein the second diameter is approximately constant around the annular surface of the flange.

20. The cylinder liner assembly of claim 15, wherein the gasket is configured to seal the cylinder liner bore in combination with a cylinder head.
